(19) United States
(12) Patent Application Publication
(10) Pub. No.: US 2011/0140975 A1
(43) Pub. Date: Jun. 16, 2011

(54) Combo antenna apparatus for vehicle

(75) Inventor: Ichiro Shigetomi, Nagoya-city (JP)

(73) Assignee: DENSO CORPORATION, Kariya-city (JP)

(21) Appl. No.: 12/927,449

(22) Filed: Nov. 15, 2010

(30) Foreign Application Priority Data
Dec. 16, 2009 (JP) 2009-285626

(51) Int. Cl. H01Q 1/32

(52) U.S. Cl. 343/713

(57) ABSTRACT

A vehicular combo antenna apparatus including multiple antennas received in a housing is disclosed. The multiple antennas include a first antenna for short range communication and a second antenna. The first and second antennas are different in directivity and are arranged along a vehicle front-rear direction. The first antenna is located to have an inclination relative to a horizontal direction, so that: a portion of the first antenna distant from the second antenna is located above another portion of the first antenna in a vertical direction; and a radiation element part of the first antenna is located above the second antenna in the vertical direction. The second antenna is located on a radio wave radiation side of the first antenna.

### CROSS REFERENCE TO RELATED APPLICATION

The present application is based on Japanese Patent Application No. 2009-285626 filed on Dec. 16, 2009, disclosure of which is incorporated herein by reference.

### BACKGROUND OF THE INVENTION

1. Field of the Invention

The present invention relates to a vehicular combo antenna apparatus, in which multiple antennas are received in a same housing.

2. Description of Related Art

Recently, a vehicular combo antenna apparatus has been proposed. In such a vehicular combo antenna apparatus, multiple antennas are received in the same housing from viewpoint of vehicle functional sophistication and design (see Patent Documents 1 and 2 for example).

In Patent Document 1, a vehicular combo antenna apparatus includes an antenna for ETC (Electronic Toll collection), an antenna for GPS (Global Positioning System) and an antenna for VICS (Vehicle Information and Communication System) as the multiple antennas. The GPS antenna and the VICS antenna are located along a left-right direction of a vehicle, which is perpendicular to a front-rear direction of the vehicle. The ETC antenna is located frontward than the GPS antenna and the VICS antenna in the front-rear direction of the vehicle.

The ETC antenna is positioned to have an inclination. More specifically, a portion of the ETC antenna close to the GPS antenna and the VICS antenna is located at the substantially same level as the GPS antenna and the VICS antenna in the vertical direction, or is located slightly lower than the GPS antenna and the VICS antenna in the vertical direction. Another portion of the ETC antenna distant from the GPS antenna and the VICS antenna is located lower than the GPS antenna and the VICS antenna in the vertical direction. An angle of this inclination is typically about 23 degrees relative to a horizontal direction.

In Patent Document 2, a vehicular integrated antenna apparatus or an in-vehicle combo antenna includes an antenna element for ETC, an antenna element for GPS/VICS, and an antenna element for telephone as multiple antennas. The GPS/VICS antenna element acts as both of a GPS antenna and a VICS antenna. The ETC antenna element and the GPS/VICS antenna element are located along the vehicle front-rear direction. Two telephone antennas elements are located in the vehicle left-right direction perpendicular to the vehicle front-rear direction, so that the ETC antenna element and the GPS/VICS antenna element are interposed between the two telephone antenna elements.

The ETC antenna element is positioned to have an inclination. More specifically, a portion of the ETC antenna element close to the GPS/VICS antenna element is located at the substantially same level as the GPS/VICS antenna element in the vertical direction, or is located slightly lower than the GPS/VICS antenna element in the vertical direction. Another portion of the ETC antenna element distant from the GPS/VICS antenna element is located lower than the GPS/VICS antenna element in the vertical direction. An angle of this inclination is typically about 23 degrees relative to a horizontal direction.

ETC (Electronic Toll Collection) is a registered trademark of Organization of Road System Enhancement. VICS (Vehicle Information and Communication System) is a registered trademark of Vehicle Information and Communication System Center.

Patent Document 1: JP-A-2006-191671

Patent Document 2: JP-A-2006-33699 corresponding to US-2006/0017646A

Now, discussion is given on a vehicular combo antenna apparatus based on the findings of the inventor of the present application. An ETC antenna is typically used to perform two-way wireless communication with an infrastructure such as a road side apparatus and the like located at a far distance forward of a vehicle. Thus, it may be preferable to ensure that the ETC antenna has a line-of-sight area with a lower elevation angle so that a metal member such as a portion of a hood, a wiper or the like of the vehicle is not located in the line-of-sight area between the ETC antenna and the infrastructure. Like this ETC antenna, when an antenna is used to perform two-way wireless communication with an infrastructure located distant from the vehicle in the vehicle front-rear direction, in other words, when an antenna has directivity in a vehicle front direction or a vehicle rear direction, it may be preferable to ensure the line-of-sight area with a lower elevation angle.

A GPS antenna receives a radio wave from an infrastructure such as satellites. Thus, it may be preferable to ensure that a line-of-sight area has a larger area around a zenith direction or a vertically upper direction so that a metal member such as a vehicle roof and the like is not located in the line-of-sight area. A VICS antenna receives a radio wave from an infrastructure such as a road side apparatus and the like. Thus, it may be preferable to ensure that a line-of-sight area has a larger area mainly around a zenith direction or a vertical upper direction so that a metal member such as a vehicle roof and the like is not located in the line-of-sight area. As can be seen from the above, when an antenna has vertically upward directivity (i.e. zenith direction directivity), it may be preferable to ensure the light-of-sight area has a larger area around the vertically upper direction i.e., zenith direction.

The line-of-sight area is an area where there is no obstacle viewed from an infrastructure and a direct view of an antenna is possible. In the other words, the line-of-sight area is an area via which the antenna can transmit and receive radio wave.

Now, discussion is given on a line-of-sight area a vehicular combo antenna apparatus 10 of a related art. As shown in FIGS. 1A and 1B, the vehicular combo antenna apparatus 10 includes multiple antennas 12 received in a housing 11. Two of the multiple antennas 12 are an ETC antenna 13 and a GPS antenna 14 located along the vehicle front-rear direction.

In the vehicular combo antenna apparatus 10, the ETC antenna 13 is located frontward than the GPS antenna 14, as shown in FIGS. 1A and 1B. The ETC antenna 13 is positioned to have such inclination that a portion of the ETC antenna 13 close to the GPS antenna 14 is located at the substantially same level as the GPS antenna 14 or located slightly lower than the GPS antenna 14 in the vertical direction, and another portion of the ETC antenna 13 distant from the GPS antenna 14 is located lower than the GPS antenna 14 in the vertical direction.

When the vehicular combo antenna apparatus 10 is placed, for example, inside an instrument panel 25 of a vehicle 20, the line-of-sight area of the ETC antenna 13 is determined by a front end portion 21a of a roof 21 of the vehicle 20, a metal portion of a wiper 23, an end portion of a hood 24, or the like, as shown in FIG. 2. In FIG. 2, the line-of-sight area of the ETC antenna 13 is illustrated by an area partitioned by the dashed lines. In particular, a lower portion of the line-of-sight area in the vertical direction is determined by the wiper 23, as shown in FIG. 2. In FIG. 2, the reference numeral 22 refers to a front windshield.

According to a structure of the related art as described above, the ETC antenna 13 is one of the two antennas located along the vehicle front-rear direction, and the ETC antenna 13 is located frontward than the GPS antenna, which is the other of the two antennas. Thus, in the vehicle front-rear direction, a distance between the ETC antenna 13 and the wiper 23 is smaller than a distance between the GPS antenna and the wiper 23. Therefore, it is difficult to set an elevation angle θ1 of the line-of-sight area of the ETC antenna 13 to a low elevation angle.

Moreover, the ETC antenna 13 is located lower than the GPS antenna 14 in the vertical direction. Thus, in the vertical direction, a distance between the ETC antenna 13 and the wiper 23 is larger than a distance between the GPS antenna 14 and the wiper 23. For this reason also, it is difficult to set the elevation angle θ1 of the line-of-sight area of the ETC antenna 13 to a low elevation angle.

A line-of-sight area of the GPS antenna 14 is determined by the front end portion 21a of the roof 21 of the vehicle 20, the metal portion of the wiper 23 or the end portion of the hood 24 (in the case of FIG. 3, the metal portion of the wiper 23), or the like, as shown in FIG. 3. In FIG. 3, the line-of-sight area of the GPS antenna 14 is illustrated by an area partitioned by the dashed lines. In particular, an upper portion of the line-of-sight area in the vertical direction is determined by the front end portion 21a of the roof 21 of the vehicle 20, as shown in FIG. 3.

According to the structure of the related art as described above, the GPS antenna 14 is one of the two antennas arranged along the vehicle front-rear direction, and the GPS antenna is located rearward than the ETC antenna, which is the other of the two antennas. Thus, as shown in FIG. 3, the front end portion 21a of the roof 21 of the vehicle 20 is projected relative to the GPS antenna 14 in the vehicle front-rear direction. Because of the interruption by the roof 21, it is difficult to enlarge a vertically upper portion of the line-of-sight area of the GPS antenna 14 around the zenith direction in particular.

### SUMMARY OF THE INVENTION

In view of the above difficulties, it is an objective of the present invention to provide a vehicular combo antenna apparatus that includes multiple antennas received in a same housing and that ensures a favorable line-of-sight area in relation to a corresponding infrastructure.

According to a first aspect of the present invention, a vehicular combo antenna apparatus includes multiple of antennas received in a same housing. The multiple antennas include two antennas that are arranged along a front-rear direction of a vehicle, and that are a first antenna for short range communication and a second antenna different in directivity from the first antenna. The first antenna is located to have an inclination with a predetermined acute angle relative to a horizontal direction, so that a first portion of the first antenna is located above a second portion of the first antenna in a vertical direction, the first portion being distant from the second antenna as compared to the second portion, the second portion, being closer to the second antenna as compared to the first portion; and a radiation element part of the first antenna is located above the second antenna in the vertical direction. The second antenna is located on a radio wave radiation side of the first antenna, the radio wave radiation side being a side of the first antenna toward which the first antenna radiates a radio wave.

According to a second aspect of the present invention, a vehicular combo antenna apparatus located inside an instrument panel of a vehicle or located on an upper surface of the instrument panel includes multiple antennas received in a same housing. The multiple antennas include two antennas that are arranged along a front-rear direction of the vehicle, and that are a third antenna having directivity generally in a vertically upward direction and a fourth antenna different in directivity from the third antenna. The third antenna is located frontward than the fourth antenna in the front-rear direction of the vehicle.

According to a third aspect of the present invention, a vehicular combo antenna apparatus located inside a rear tray of a vehicle or located on an upper surface of the rear tray include multiple antennas received in a same housing. The multiple antennas include two antennas that are arranged along a front-rear direction of the vehicle, and that are a third antenna having directivity generally in a vertically upward direction and a fourth antenna different in directivity from the third antennal. The third antenna is located rearward than the fourth antenna in the front-rear direction of the vehicle.

According to the above vehicular combo antenna apparatus, it is possible to ensure a favorable line-of-sight area in relation to a corresponding infrastructure

### BRIEF DESCRIPTION OF THE DRAWINGS

The above and other objects, features and advantages of the present invention will become more apparent from the following detailed description made with reference to the accompanying drawings. In the drawings:

FIG. 1A is a plan view illustrating a positional relationship between two antennas of a vehicular combo antenna apparatus of a related art, the plan view being viewed in a vertical direction;

FIG. 1B is a plan view illustrating the positional relationship between the two antennas of the vehicular combo antenna apparatus of the related art, the plan view being viewed in a horizontal direction;

FIG. 2 is a diagram illustrating a line-of-sight area of a short range communication antenna when the vehicular combo antenna apparatus shown in FIGS. 1A and 1B is attached to an instrument panel;

FIG. 3 is a diagram illustrating a line-of-sight area of a GPS antenna when the vehicular combo antenna apparatus shown in FIGS. 1A and 1B is attached to the instrument panel;

FIG. 4 is an exploded perspective view illustrating a schematic structure of a vehicular combo antenna apparatus of a first embodiment;

FIG. 5A is a plan view illustrating a positional relationship between two antennas of the vehicle combo antenna apparatus shown in FIG. 4, the plan view being viewed in the vertical direction;

FIG. 5B is a plan view illustrating the positional relationship between the two antennas of the vehicle combo antenna apparatus shown in FIG. 4, the plan view being viewed in the horizontal direction;

FIG. 6 is a diagram illustrating a line-of-sight area of a short range communication antenna when the vehicular combo antenna apparatus shown in FIG. 4 is attached to an instrument panel;

FIG. 7 is a diagram illustrating a line-of-sight area of a GPS/VICS antenna when the vehicular combo antenna apparatus shown in FIG. 4 is attached to the instrument panel;

FIG. 8 is a diagram illustrating a line-of-sight area of a short range communication antenna when a vehicular combo antenna apparatus of a second embodiment is attached to a rear tray;

FIG. 9 is a diagram illustrating a line-of-sight area of a GPS/VICS antenna when the vehicular combo antenna apparatus of the second embodiment is attached to the rear tray;

FIG. 10A is a plan view illustrating a positional relationship between two antennas of a vehicular combo antenna apparatus of a third embodiment, the plan view being viewed in the vertical direction;

FIG. 10B is a plan view illustrating the positional relationship between the two antennas of the vehicular combo antenna apparatus of the third embodiment, the plan view being viewed in the horizontal direction;

FIG. 11 is a diagram illustrating a line-of-sight area of a GPS/VICS antenna when a vehicular combo antenna apparatus of a fourth embodiment is attached to an instrument panel; and

FIG. 12 is a diagram illustrating a line-of-sight area of a GPS/VICS antenna when a vehicular combo antenna apparatus of a fifth embodiment is attached to a rear tray.

### DETAILED DESCRIPTION OF EMBODIMENTS

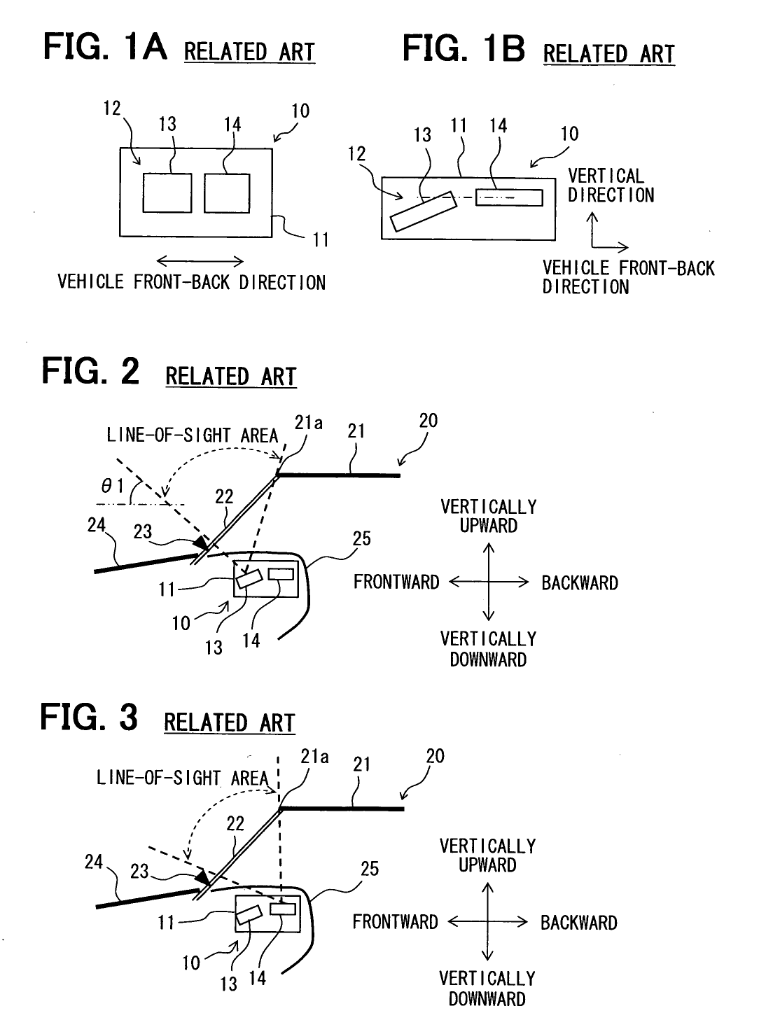

Embodiments of the present invention will be described below with reference to the accompanying drawings. As for some parts of a vehicle, like numerical references are used to refer to like parts between the below-described embodiments and the related art shown in FIGS. 1A, 1B, 2 and 3. As for some parts of a vehicular combo antenna apparatus, when parts are similar between the embodiments and the related art, reference numerals in the embodiments are 100 plus those used in related art. Definitions of directions in the embodiments are the same as those in the related art. In the present disclosure, a vehicle rear direction is also referred to as a vehicle back direction.

### First Embodiment

A feature of the present embodiment may not be structures of respective antennas. A feature may be antenna characteristics of two antennas located along a vehicle front-rear direction and an arrangement of the two antennas suited to the antenna characteristics.

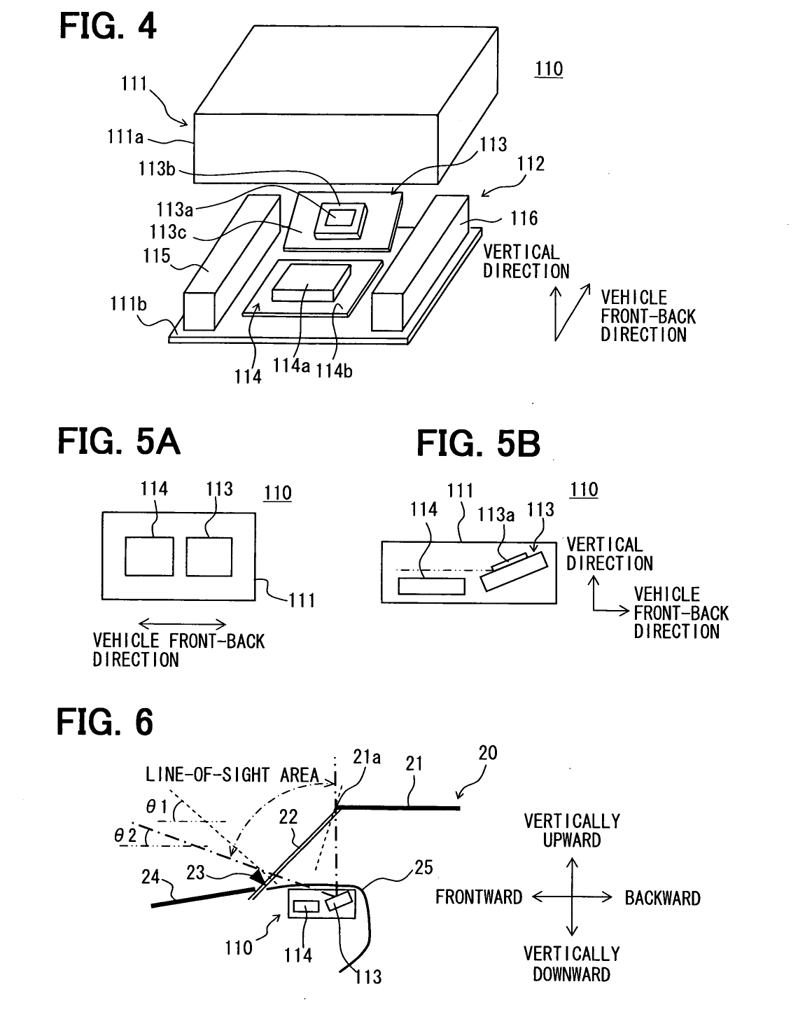

As shown in FIG. 4, a vehicular combo antenna apparatus 110 includes a housing 111 and multiple antennas 112 received in the same housing 111. The multiple antennas 112 include a short range communication antenna 113 and a GPS/VICS antenna 114 as two antennas located along the vehicle front-rear direction. The short range communication antenna 113 and the GPS/VICS antenna 114 are different from each other in directivity. In addition to the short range communication antenna 113 and the GPS/VICS antenna 114, the multiple antennas 112 further include two telephone antennas 115, 116 for telephone communication. The short range communication antenna 113 can act as a first antenna, and the GPS/VICS antenna 114 can act as a second antenna.

In the vehicular combo antenna apparatus 110 of the present embodiment, as described later, a positional relationship between the multiple antennas 112 is determined in connection with placing the vehicular combo antenna apparatus 110 into an inside of the instrument panel 25 of the vehicle 20. In the following, position of each of the multiple antennas 112 and the like will be described on a basis of a situation in which the vehicular combo antenna apparatus 110 is mounted to the vehicle.

The housing 111 protects the multiple antennas 112 and is made of a resin material for example. The housing 111 includes a case 111a and a cover 111b for closing or covering the case 111a. The case 111a is located on a radiator element formation side of the multiple antennas 112.

The case 111a has a box shape with a closed end and an open end. The case 111a has a predetermined depth in the vertical direction in order to receive therein the multiple antennas 112. The cover 111b closes or covers the open end of the case 111a. With the cover 111b closing or covering the open end of the case 111a, the case 111a and the cover 111b are fixed to each other by a known fixation method such screwing, snap fitting and the like to form the housing 111.

In the present embodiment, in order for the cover 111b to function as a ground of the multiple antennas 112, the cover 111b is configured to further play a role of a ground plane. For example, a metallic member with a planer plate shape is employed as the cover 111b. However, a ground plane may be provided separately from the cover 111b.

The multiple antennas 112 are mounted to one surface of the cover 111b. Each antenna 112 may be held at a predetermined position on the one surface of the cover 111b by a holding member on an as-needed basis.

The short range communication antenna 113 is an antenna for two-way wireless communication in a small range, e.g., a relatively short range between a few meters and a few tens meters, used in ITS (Intelligent Transport System). For example, the short range communication antenna 113 may include an antenna for DSRC (Dedicated Short Range Communications). The short range communication antenna 113 may include an antenna for WAVE (Wireless for the Vehicular Environment) in US.

A center frequency of radio wave used in the short range communication is 5.8 GHz in Japan and 5.9 GHz in US. It is conceivable that an infrastructure for two-way communication with the short range communication antenna 113 is, for example, a road side apparatus, an in-vehicle apparatus (e.g., antenna) of another vehicle, or the like.

In the present embodiment, an ETC antenna is employed as an example of the short range communication antenna 113. As well known, an ETC system, which is one example of a DSRC-related system, includes the following system. When a vehicle is traveling on a toll road having a toll station such as an express way and the like, wireless communication between the short range communication antenna 113 (e.g., the ETC antenna) and a road side apparatus (i.e., base station) disposed in the toll station enables automatic payment of the toll without stop of the vehicle.

The short range communication antenna 113 includes a radiation element 113a having a substantially rectangular shape, a dielectric body 113b having a rectangular cuboidal shape, and a circuit board 113c. The radiation element 113a is formed on one surface of the dielectric body 113b. The one surface is also referred to as a radiation element formation surface. A ground (not shown) is formed on a rear surface of the dielectric body 113b, which is opposite to the radiation element formation surface. The dielectric body 113b is mounted to the circuit board 113c so that the rear surface opposite to the radiation element formation surface acts as a mounting surface. In the present embodiment, the radiation element 113a is configured by patterning a conductive foil or a conductive membrane into the substantially rectangular shape. Alternatively, as the radiation element 113a, it is possible to employ a metal plate processed into a predetermined shape, a metal material shaped into a predetermined shape, or the like.

A matching circuit, a wireless circuit or the like are formed in the circuit board 113c. The radiation element 113a is electrically connected with the matching circuit and the wireless circuit. The circuit in the circuit board 113c is connected with a connector (not shown) for short range communication via a coaxial cable (not shown). Via the connector, the circuit in the circuit board 113c is connected with, for example, a navigation apparatus (not shown).

A holding member (not shown) is located on a rear surface side of the circuit board 113c. The rear surface side is opposite to a short range communication antenna mounting side. Due to the holding member, the circuit board 113c and the dielectric body 113b, which has the radiation element 113a and is mounted to the circuit board 113c, are inclined relative to the cover 111b. In the present embodiment, with the vehicular combo antenna apparatus 110 being mounted to the vehicle, the cover 111b is positioned parallel to a horizontal direction. Thus, the short range communication antenna 113 has an inclination of about 23 degrees relative to one surface of the cover 111b, that is, relative to the horizontal direction. A reason for providing this inclination is that an arrival direction of the radio wave from the road side apparatus is inclined by about 23 degrees relative to the vertical direction.

The GPS/VICS antenna 114 can act as an antenna for GPS (Global Positioning System) and an antenna for VICS (Vehicle Information and Communication System). Note that, in typical, each of the VICS antenna and the GPS antenna has directivity mainly in the zenith direction.

In the present embodiment, the GPS/VICS antenna 114 includes a dielectric body 114a and a circuit board 114b. The dielectric body 114a has a rectangular cuboidal shape. A radiation element (not shown) having a substantially rectangular shape is formed on one surface of the dielectric body 114a. The one surface is also referred to as a radiation, element formation surface. A ground (not shown) is, formed on a rear surface of the dielectric body 114a, which is opposite to the radiation element formation surface. The dielectric body 114a is mounted to the circuit board 114b so that the rear surface opposite to the radiation element formation surface acts as a mounting surface.

A matching circuit, a wireless circuit or the like are formed in the circuit board 114b. The radiation element is electrically connected with the matching circuit and the wireless circuit. The circuit in the circuit board 114b is connected with a connector (not shown) for GPS/VICS via a coaxial cable (not shown). Via the connector, and the circuit in the circuit board 114b is connected with, for example, a navigation apparatus (not shown).

As for the GPS/VICS antenna 114, an arrival direction of a radio wave from an infrastructure such as a satellite, a road side apparatus and the like is a substantially vertical upper direction, i.e., the zenith direction. Therefore, with the vehicular combo antenna apparatus 110 being mounted to a vehicle, the GPS/VICS antenna 114 is positioned relative to the cover 111b, so that the GPS/VICS antenna 114 is parallel to one surface of the cover 111b, i.e., parallel to the horizontal direction. More specifically, a dielectric body mounting surface and the radiation element formation surface of the circuit board 114b are parallel to the horizontal direction.

With the vehicular combo antenna apparatus 110 being mounted to a vehicle, the above-described two antennas 113, 114 have a positional relationship therebetween. The two antennas 113, 114 are arranged along the front-rear direction of the vehicle, as shown in FIGS. 4, 5A and 5B. As shown in FIG. 5B, the ETC antenna acting as the short range communication antenna 113 is positioned to have an inclination with a predetermined acute angle (e.g., about 23 digress) relative to the horizontal direction (i.e., the front-rear direction of the vehicle). More specifically, a portion of the short range communication antenna 113 distant from the GPS/VICS antenna 114 is located, in the vertical direction, above another portion of the short range communication antenna 113 close to the GPS/VICS antenna 114.

In the present embodiment, a portion of the short range communication antenna 113 close to the GPS/VICS antenna 114 is located at the substantially same level as the GPS/VICS antenna 114 in the vertical direction. Another portion of the short range communication antenna 113 distant from the GPS/VICS antenna 114 is located above the GPS/VICS antenna 114 in the vertical direction. The radiation element 113a (i.e., a radiation element part) of the short range communication antenna 113 is located above the GPS/VICS antenna 114 in the vertical direction.

In the vehicle front-rear direction, the GPS/VICS antenna 114 is located on a radio wave radiation side of the short range communication antenna 113. The radio wave radiation side is one side toward which the short range communication antenna 113 radiates a radio wave. In the present embodiment, the GPS/VICS antenna 114 is located frontward (i.e., closer to a front of the vehicle) than the short range communication antenna 113.

The telephone antennas 115, 116 are configured by processing of a metal wire or metal plate. Directivity of each telephone antenna 115, 116 is non-directional in the horizontal direction. Therefore, position of each telephone antenna 115, 116 may not be specifically limited. In particular, position in the vehicle front-rear direction may not be specifically limited.

In the present embodiment, the telephone antennas 115, 116 are mounted to one surface of the cover 111b so that: the two antennas 113, 114, which when being mounted to the vehicle are arranged along the front-rear direction of the vehicle, are located between the telephone antennas 115, 116; and the telephone antennas 115, 116 are arranged along the vehicle left-right direction, which is perpendicular to the vehicle front-rear direction. One end of each antenna 115, 116 is connected with the cover 111b, and another end of the antenna 115, 116 is connected with a wireless device (not shown) for telephone so that power is supplied to the antenna 115, 116.

In the following, explanation will be given on respective line-of-sight areas of the short range communication antenna 113 and the GPS/VICS antenna 114, which are arranged along the vehicle front-rear direction when being mounted to the vehicle.

First, the line-of-sight area of the short range communication antenna 113 of the present embodiment is described with reference to FIG. 6. In FIG. 6, the line-of-sight area of the short range communication antenna 113 is illustrated by an area partitioned by the one-dotted dashed lines. As a comparison example, In FIG. 6, a line-of-sight area of a short range communication antenna of a related art is illustrated by an area partitioned by the dashed lines. The comparison example is based on an assumption that the vehicular combo antenna apparatus 10 of the related art and the vehicular combo antenna apparatus 110 are the same in size and attachment position to the vehicle. The line-of-sight area of the comparison example partitioned by the dashed lines corresponds to the line-of-sight area shown in FIG. 2.

As described above, in the present embodiment, the radiation element 113a of the short range communication antenna 113 is located above the GPS/VICS antenna 114 in the vertical direction. Thus, when the present embodiment and the comparison example are the same in the attachment position to the vehicle, the radiation element 113a of the short range communication antenna 113 of the present embodiment is located above that of the short range communication antenna 13 (ETC antenna 13) of the related art in the vertical direction.

For example, when the radiation element 113a of the short range communication antenna 113 of the present embodiment and the radiation element of the short range communication antenna 13 (ETC antenna 13) of the related art are located at the same position in the vehicle front-rear direction, the radiation element 113a of the present embodiment is located above the radiation element of the related art in the vertical direction. Therefore, according to the present embodiment, elevation angle of the line-of-sight area can be made a lower elevation angle.

In the present embodiment, the GPS/VICS antenna 114 is located on the radio wave radiation side of the short range communication antenna 113 and is located frontward than the short range communication antenna 113 in the vehicle front-rear direction. In the comparison example on the other hand, the GPS/VICS antenna 114 is located on an opposite side of the short range communication antenna 113 from the radio wave radiation side and is located rearward than the short range communication antenna 113. Thus, when the present embodiment and the related art are the same in attachment position to the vehicle, the present embodiment has a longer distance between a part of the vehicle determining a vertically lower portion of the line-of-sight area and the short range communication antenna 113 (in particular the radiation element 113a), compared to the comparison example. In the above, the part of the vehicle determining the vertically lower portion of the line-of-sight area is, for example, a metal portion of the wiper 23, as shown in FIG. 6.

For example, when the short range communication antenna 113 (the radiation element 113a) of the present embodiment and the short range communication antenna 13 (ETC antenna 13) of the related art are located at the same position in the vertical direction, the short range communication antenna 113 of the present embodiment is located rearward than the short range communication antenna 13 of the related art in the vehicle front-rear direction. Therefore, according to the present embodiment, the elevation angle of the line-of-sight area can be made a lower elevation angle.

The short range communication antenna 113 is positioned to have the inclination with the predetermined acute angle relative to the horizontal direction, so that the radiation element 113a is located above the GPS/VICS antenna 114 in the vertical direction. Therefore, while the GPS/VICS antenna 114 is located on the radio wave radiation side of the short range communication antenna 113, e.g., while the GPS/VICS antenna 114 is located frontward in the vehicle front-rear direction, the short range communication antenna 113 can conduct favorable two-way wireless communication with the infrastructure corresponding to the short range communication antenna 113.

According to the vehicular combo antenna apparatus 110 of the present embodiment, the elevation angle θ2 of the line-of-sight area of the ETC antenna acting as the short range communication antenna 113 can be made lower than the elevation angle θ1 of the line-of-sight area of the related art. That is, it is possible to ensure the line-of-sight area more favorable than that of the related art. In the above, the line-of-sight area of the ETC antenna can be defined in relation to the infrastructure corresponding to the ETC antenna, e.g., in relation to the road side apparatus.

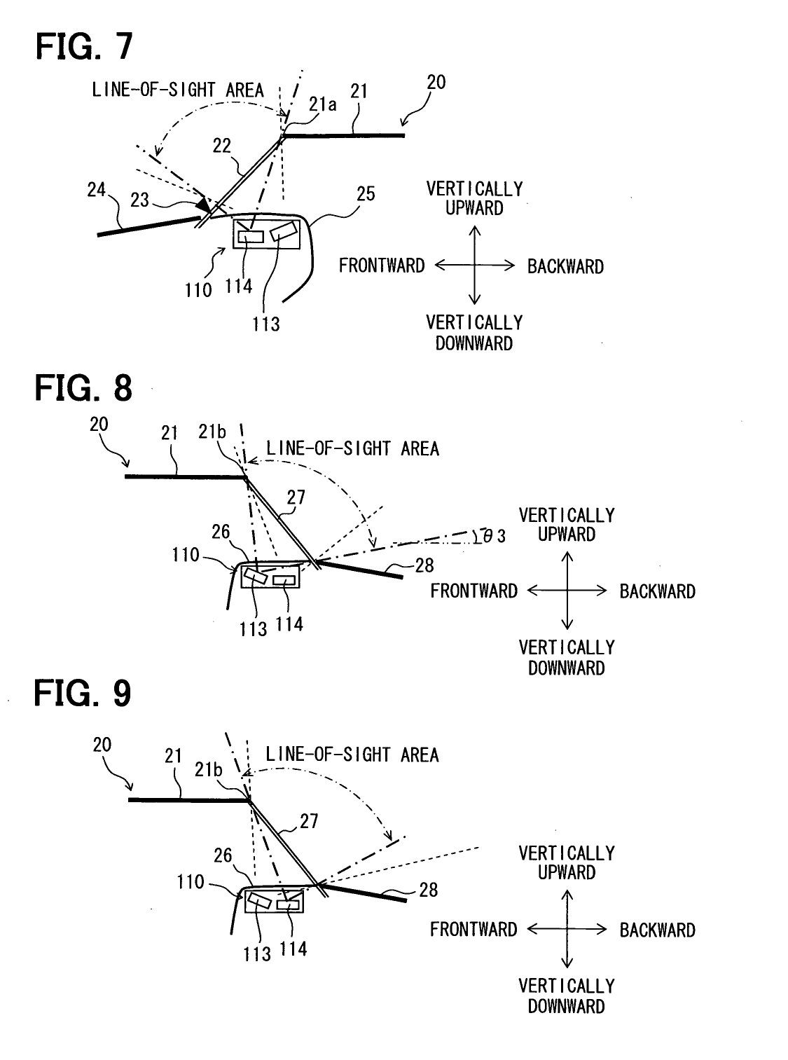

Next, the line-of-sight area of the GPS/VICS antenna 114 of the present embodiment is described with reference to FIG. 7. In FIG. 7, the line-of-sight area of the GPS/VICS antenna 114 of the present embodiment is illustrated by an area partitioned by the one-dotted dashed lines. As a comparison example, in FIG. 7, a line-of-sight area of a GPS/VICS antenna of the vehicular combo antenna apparatus 10 of the related art is illustrated by an area partitioned by the dashed lines. The line-of-sight area of the comparison example is based on an assumption that the vehicular combo antenna apparatus 10 of the related art and the vehicular combo antenna apparatus 110 of the present embodiment are the same in size and attachment position to the vehicle. The line-of-sight area of the comparison example partitioned by the dashed lines corresponds to the line-of-sight area of the GPS antenna 14 of the related art shown in FIG. 3.

In the present embodiment as described above, the GPS/VICS antenna 114 is located on the radio wave radiation side of the short range communication antenna 113. More specifically, the GPS/VICS antenna 114 is located frontward than the short range communication antenna 113 in the vehicle front-rear direction. Thus, when the present embodiment and the related art are the same in attachment position to the vehicle 20, the GPS/VICS antenna 114 of the present embodiment is located frontward compared to the related art.

For example, when the GPS/VICS antenna 114 of the present embodiment and the GPS/VICS antenna (see the GPS antenna 14 in FIG. 3) of the related art are located at the same position in the vertical direction, the GPS/VICS antenna 114 of the present embodiment is located frontward than the GPS/VICS antenna of the related art in the vehicle front-rear direction. Therefore, it is possible to enlarge the line-of-sight area. In particular, it is possible to enlarge a zenith-direction-centered portion (i.e., a vertically-upward-centered portion) of the line-of-sight area in the vehicle front-rear direction. In the above, the zenith-direction-centered portion of the line-of-sight area is determined by a positional relationship between the front end portion 21a of the roof 21 of the vehicle 20 and the GPS/VICS antenna 114.

According the present embodiment in particular, since the GPS/VICS antenna 114 is located frontward than the short range communication antenna 113 in the vehicle front-rear direction, and since the two antennas 113, 114 have a predetermined interval therebetween, the GPS/VICS antenna 114 is located frontward than the front end portion 21a of the roof 21 of the vehicle 20. Therefore, it is possible to enlarge the line-of-sight area. In particular, it is possible to enlarge a zenith-direction-centered portion (i.e., a vertically-upward-centered portion) of the line-of-sight area.

As can be seen from the above, according to the vehicular combo antenna apparatus 110 of the present embodiment, it is possible to enlarge the line-of-sight area between the GPS/VICS antenna 114 and the infrastructure corresponding to the GPS/VICS antenna with respect to the zenith direction, as compared to the line-of-sight area of the related art, as shown in FIG. 7. Therefore, the present embodiment can ensure the line-of-sight more favorable than the related art.

Since the vehicular combo antenna apparatus 110 includes the multiple antennas 112 in the housing 111, the vehicular combo antenna apparatus 110 may have a larger size as compared to a case where an antenna apparatus has only one antenna. In the present embodiment, since the vehicular combo antenna apparatus 110 is placed inside the instrument panel 25 of the vehicle 20, design improvement is achievable.

However, position of the vehicular combo antenna apparatus in the vehicle is not limited to the above-described example. For example, when the line-of-sight area of each antenna 113, 114 is took into account, the vehicular combo antenna apparatus 110 may be placed on an upper surface of the instrument panel 25. Alternatively, the vehicular combo antenna apparatus 110 may be placed directly below the front windshield and may be placed at a part other than the instrument panel 25. However, when the low elevation angle of the line-of-sight area of the short range communication antenna 113 is took into account in particular, it may be preferable that the vehicular combo antenna apparatus 110 be placed inside the instrument panel 25 and in the vicinity of the upper surface of the instrument panel 25.

In the present embodiment, the short range communication antenna 113 and the GPS/VICS antenna 114 respectively act a first antenna and a second antenna, which are arranged along the vehicle front-rear direction. That is, the GPS/VICS antenna 114 acts as the second antenna. Alternatively, an antenna for GPS by itself or the antenna for VICS by itself may be employed as the second antenna. Alternatively, the antenna for GPS and the antenna for VICS may be arranged in the vehicle left-right direction perpendicular to the vehicle front-rear direction, and these antennas for GPS and VICS and the short range communication antenna 113 may be arranged along the front-rear direction of the vehicle.

### Second Embodiment

The first embodiment illustrates the vehicular combo, antenna apparatus 110 configured to be mounted to the instrument panel 25 of the vehicle. In other words, the vehicular combo antenna apparatus 110 is configured so that the line-of-sight area of each antenna 112 is ensured via the front windshield 22.

In the present embodiment by contrast, the vehicular combo antenna apparatus 110 is configured to be placed inside a rear tray 26 of the vehicle. In other words, the vehicular combo antenna apparatus 110 is configured so that the line-of-sight area of each antenna 112 is ensured via a rear windshield 27.

Components of the vehicular combo antenna apparatus 110 of the present embodiment may be the substantially same as those of the first embodiment. A difference from the first embodiment includes the following. An antenna for a traffic information system is adopted as the short range communication antenna 113 (first antenna), in place of the ETC antenna for communicating with the road side apparatus located forward of the vehicle. The antenna for a traffic information system can perform two-way communication with an infrastructure such as a traffic light and the like.

In a state of being mounted to the vehicle 20, the short, range communication antenna 113 is located frontward than the GPS/VICS antenna 114.

The multiple antennas 112 of the vehicular combo antenna apparatus 110 of the present embodiment include the short range communication antenna 113 and the GPS/VICS antenna 114, which are arranged in the front-rear direction of the vehicle when being mounted to the vehicle. In the following, explanation will be given on the line-of-sight areas of the short range communication antenna 113 and the GPS/VICS antenna 114.

First, the line-of-sight area of the short range communication antenna 113 of the present embodiment is described with reference to FIG. 8. In FIG. 8, the line-of-sight area of the short range communication antenna 113 of the present embodiment is illustrated by an area partitioned by the one-dotted dashed lines. As a comparison example, in FIG. 8, a line-of-sight area of a short range communication antenna of the related art is illustrated by an area partitioned by the dashed lines. This comparison example is based on an assumption that: the vehicle combo antenna apparatus 110 of the present embodiment and the vehicle combo antenna apparatus of the related art are the same in size and attachment position to the vehicle; and the short range communication antenna of the related art is located rearward than the GPS/VICS antenna in the vehicle front-rear direction.

In the present embodiment also, the radiation element 113a (i.e., a radiation element part) of the short range communication antenna 113 is located above the GPS/VICS antenna 114 in the vertical direction. Thus, when the present embodiment and the Comparison example are the same in the attachment position to the vehicle, the radiation element 113a of the short range communication antenna 113 of the present embodiment is located above that of the short range communication antenna 13 (ETC antenna 13) of the related art in the vertical direction. Therefore, according to the present embodiment, the elevation angle of the line-of-sight area can be made a low elevation angle.

In the present embodiment, the GPS/VICS antenna 114 is located on the radio wave radiation side of the short range communication antenna 113, more specifically, located rearward than the short range communication antenna 113 in the vehicle front-rear direction. In the related art on the other hand, the GPS/VICS antenna is located on an opposite side of the short range communication antenna 113 from the radio wave radiation side and is located frontward than the short range communication antenna 113. Thus, when the present embodiment and the related art are the same in attachment position to the vehicle, the present embodiment can have a larger distance between a part of the vehicle determining a vertically lower portion of the line-of-sight area and the short range communication antenna 113 (e.g., the radiation element 113a), as compared to the related art. Therefore, according to the present embodiment, the elevation angle of the line-of-sight area can be made a low elevation angle. In the above, the part of the vehicle determining a vertically lower portion of the line-of-sight area of the short range communication antenna 113 is for example a trunk lid 28 of a vehicle body, as shown in FIG. 8.

Although not shown in the drawings, the short range communication antenna 113 in the present embodiment also is located to have an inclination with a predetermined acute angle relative to the horizontal direction so that the radiation element 113a is located above the GPS/VICS antenna 114 in the vertical direction. Therefore, while the GPS/VICS antenna 114 is located on the radio wave radiation side of the short range communication antenna 113 and located rearward in the front-direction of the vehicle, the short range communication antenna 113 can perform favorable two-way communication with an infrastructure corresponding to the short range communication antenna 113.

As can be seen from the above, according to the vehicular combo antenna apparatus 110 of the present embodiment, elevation angle θ3 of the line-of-sight area between the short range communication antenna 113 and a corresponding infrastructure can be a lower elevation angle compared to the comparison example, as shown in FIG. 8. Therefore, the present embodiment can ensure the line-of-sight area more favorable than the related art. In the above, the short range communication antenna 113 may include the antenna for a traffic information system, and the corresponding infrastructure may include a traffic light.

Next, the line-of-sight area of the GPS/VICS antenna 114 of the present embodiment is described with reference to FIG. 9. In FIG. 9, the line-of-sight area of the GPS/VICS antenna 114 of the present embodiment is illustrated by an area partitioned by the one-dotted dashed line. As a comparison example, in FIG. 9, a line-of-sight area of a GPS/VICS antenna of the related art is illustrated by an area partitioned by the dashed lines. This comparison example is based on an assumption that: the vehicle combo antenna apparatus 110 of the present embodiment and the vehicle combo antenna apparatus of the related art are the same in size and attachment position to the vehicle; and the GPS/VICS antenna is located frontward in the vehicle front-rear direction.

In the present embodiment, the GPS/VICS antenna 114 is located on the radio wave radiation side of the short range communication antenna 113, more specifically, located rearward than the short range communication antenna 113 in the vehicle front-rear direction. Thus, when the present embodiment and the related art are the same in attachment position to the vehicle 20, the GPS/VICS antenna 114 of the present embodiment is located rearward than that of the related art. Therefore, the present embodiment can enlarge the line-of-sight area, in particular a zenith-direction-centered portion of the line-of-sight area in the vehicle front-rear direction. In the above, the zenith-direction-centered portion of the line-of-sight area is determined by, for example, a positional relationship between the rear end portion 21b of the roof 21 of the vehicle 20 and the GPS/VICS antenna 114.

According the present embodiment in particular, since the GPS/VICS antenna 114 is located rearward than the short range communication antenna 113 in the vehicle front-rear direction, and since the two antennas 113, 114 have a predetermined interval therebetween, the GPS/VICS antenna 114 is located rearward than the rear end portion 21b of the roof 21 of the vehicle 20, as shown in FIG. 9. Therefore, it is possible to enlarge the line-of-sight area, in particular a portion of the line-of-sight area around the zenith direction (i.e., vertically upward direction).

As can be seen from the above, according to the vehicular combo antenna apparatus 110 of the present embodiment, it is possible to enlarge the line-of-sight area between the GPS/VICS antenna 114 and the infrastructure corresponding to the GPS/VICS antenna 114 with respect to the zenith direction as compared to the line-of-sight area of the related art, as shown in FIG. 9. Therefore, the present embodiment can ensure a line-of-sight area more favorable than the related art.

In the present embodiment, since the vehicular combo antenna apparatus 110 is placed inside the rear tray 26 of the vehicle 20, design improvement is achievable.

However, position of the vehicular combo antenna apparatus 110 of the present embodiment in the vehicle is not limited to the above-described example. For example, when the line-of-sight area of each antenna 113, 114 is took into account, the vehicular combo antenna apparatus 110 may be placed on an upper surface of the rear tray 26. Alternatively, the vehicular combo antenna apparatus 110 may be placed directly below the rear windshield 27 and may be placed at a part other than the rear tray 26. However, when the low elevation angle of the line-of-sight area of the short range communication antenna 113 is took into account in particular, it may be preferable that the vehicular combo antenna apparatus 110 be placed inside the rear tray 26 and in the vicinity of the upper surface of the rear tray 26.

In the present embodiment also, the short range communication antenna 113 and the GPS/VICS antenna 114 respectively act as the first antenna and the second antenna, which are arranged along the vehicle front-rear direction. That is, the antenna 114 for the GPS/VICS acts as a second antenna. Alternatively, the antenna for GPS by itself or the antenna for VICS by itself may be solely employed as the second antenna. Alternatively, the antenna for GPS and the antenna for VICS may be arranged in the vehicle left-right direction perpendicular to the vehicle front-rear direction, and these antennas for GPS and VICS and the short range communication antenna 113 may be arranged along the vehicle front-rear direction.

In the present embodiment, the vehicle does not have a wiper on a rear side. However, even if the vehicle has a wiper on the rear side, the present embodiment can involve the above advantages.

### Third Embodiment

In the first and second embodiments, the short range communication antenna 113 is shown as an example of the first antenna. An antenna having directivity generally in the zenith direction, more specifically the GPS/VICS antenna 114, is shown as an example of the second antenna.

However, as a second antenna, it is possible to employ an antenna other than the antenna having directivity generally in the zenith direction. An antenna that is different from the first, antenna in directivity may suffice as the second antenna.

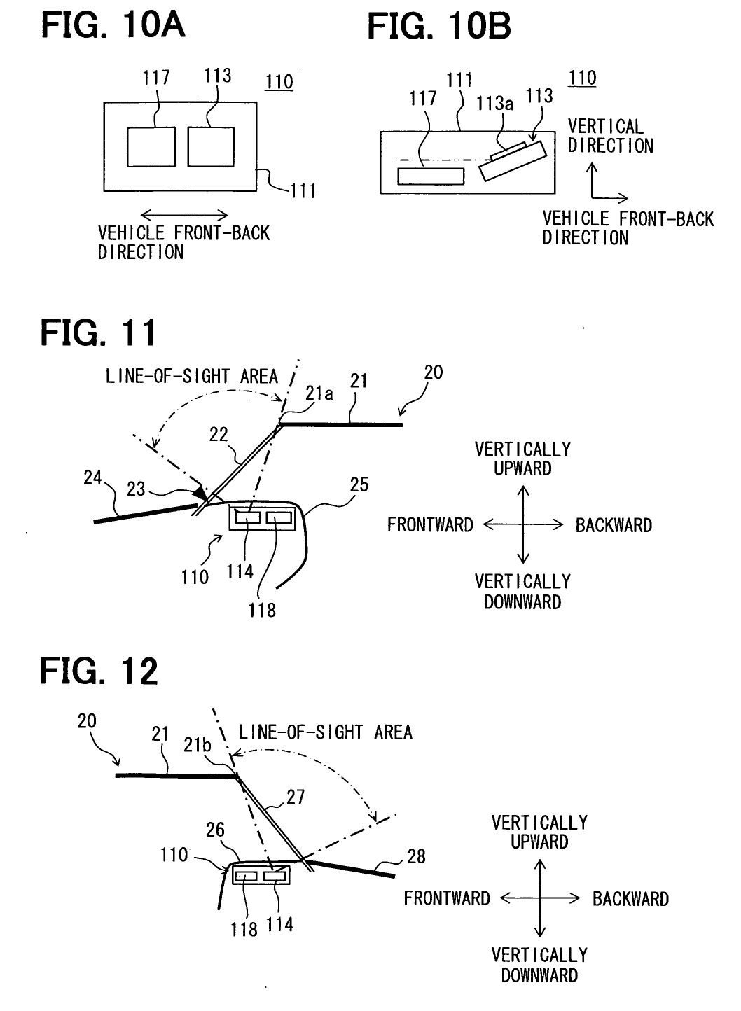

For example, as shown in FIGS. 10A and 10B, a telephone antenna 117 acts as the second antenna. The telephone antenna 117 and the short range communication antenna 113 are arranged along the vehicle front-rear direction.

Even when the above structure is employed, the line-of-sight area between the short range communication antenna 113 and the infrastructure corresponding to the short range communication antenna 113 can have a lower elevation angle than the line-of-sight area of the related art, in a manner similar to the first and second embodiments. Therefore, the present embodiment can ensure a line-of-sight area more favorable than the related art.

The second antenna is not limited to the telephone antenna. Since the second antenna is located on the radio wave radiation side of the first antenna (e.g., short range communication antenna 113), it may be preferable that a vertical direction dimension of the second antenna be small, in respect of size of the vehicular combo antenna apparatus 110.

### Fourth Embodiment

In the foregoing embodiments, the vehicular combo antenna apparatus 110 includes the two antennas arranged along the vehicle front-rear direction, and one of the two antennas is the short range communication antenna 113.

In the present embodiment, the vehicular combo antenna' apparatus 110 is placed inside the instrument panel 25 or on the upper surface of the instrument panel 25. As the two antenna, the vehicular combo antenna apparatus 110 includes a third antenna having directivity generally in the zenith direction (i.e., vertically upward directivity) and a fourth antenna having directivity different from the third antenna. The third antenna is located frontward than the fourth antenna in the vehicle front-rear direction.

In the vehicular combo antenna apparatus illustrated in FIG. 11, the GPS/VICS antenna 114 is employed as the third antenna. The telephone antenna 118 is employed as the fourth antenna.

Now, the line-of-sight area of the GPS/VICS antenna 114 of the present embodiment will be described with reference to FIG. 11. In FIG. 11, the line-of-sight area of the GPS/VICS antenna 114 of the present embodiment is illustrated by an area partitioned by the one-dotted dashed lines.

In the present embodiment, as described above, the GPS/VICS antenna 114 acting as one of the two antennas is located frontward than the telephone antenna 118 acting as the other of the two antennas in the vehicle front-rear direction. Therefore, as shown in FIG. 11, it is possible to enlarge the line-of-sight area of the GPS/VICS antenna 114. In particular, it is possible to enlarge a zenith-direction-centered portion of the line-of-sight area of the GPS/VICS antenna 114 in the vehicle front-rear direction, as compared to a case where the GPS/VICS antenna 114 is located rearward than the telephone antenna 118. In the above, the zenith-direction centered portion of the GPS/VICS antenna 114 is determined by, for example, a positional relationship between the front end portion 21a of the roof 21 of the vehicle 20 and the GPS/VICS antenna 114.

According the present embodiment in particular, since the GPS/VICS antenna 114 is located frontward than the telephone antenna 118 in the vehicle front-rear direction, and since the two antennas 113, 118 have a predetermined interval therebetween, the GPS/VICS antenna 114 is located frontward than the front end portion 21a of the roof 21 of the vehicle, as shown in FIG. 11. Therefore, it is possible to enlarge the line-of-sight area, in particular, a zenith-direction-centered portion (i.e., a vertically-upward portion) of the line-of-sight area.

As can be seen from the above, according to the vehicular combo antenna apparatus 110 of the present embodiment, it is possible to enlarge the line-of-sight area between the GPS/VICS antenna 114 and the infrastructure corresponding to the GPS/VICS antenna 114 with respect to the zenith direction, as shown in FIG. 11.

Moreover, as shown in FIG. 11, since the vehicular combo antenna apparatus 110 is placed inside the instrument panel 25 of the vehicle 20, design improvement is achievable. However, the vehicular combo antenna apparatus 110 may be placed on the upper surface of the instrument panel 25 of the vehicle 20. Alternatively, the vehicular combo antenna apparatus 110 may be placed directly below the front windshield 22 and may be placed at a part other than the instrument panel 25.

The third antenna, which has directivity generally in the zenith direction, is not limited to the GPS/VICS antenna 114. The antenna for GPS by itself or the antenna for VICS by itself may be solely employed as the third antenna. Alternatively, an antenna having directivity generally in the zenith direction other than the above-described antennas may be employed as the third antenna.

The fourth antenna is not limited to the telephone antenna 118. An antenna having directivity different from the third antenna may suffice as the fourth antenna. Therefore, the short range communication antenna 113 illustrated in the first, second and third embodiments may be employed as the fourth antenna. In this case, the short range communication antenna 113 can act as the first antenna or the fourth antenna, and the GPS/VICS antenna 114 can act as the second antenna or the third antenna.

### Fifth Embodiment

In the fourth embodiment, the vehicular combo antenna apparatus 110 is placed inside the instrument panel 25 or placed on the upper surface of the instrument panel 25. Further, the vehicular combo antenna apparatus 110 includes the two antennas, which are the third antenna having directivity generally in the zenith direction (i.e., vertically upward directivity) and the fourth antenna having the directivity different from the third antenna.

In the present embodiment by contrast, the vehicular combo antenna apparatus 110 including the third antenna and the fourth antenna is placed inside the rear tray 26 or placed on the upper surface of the rear tray 26. The third antenna is located rearward than the fourth antenna in the vehicle front-rear direction.

The vehicular combo antenna apparatus 110 illustrated in FIG. 12 employs the GPS/VICS antenna 114 as the third antenna, like the vehicular combo antenna apparatus 110 of the fourth embodiment does. The telephone antenna 118 is employed as the fourth antenna.

In the following, explanation is given on the line-of-sight area of the GPS/VICS antenna 114 of the present embodiment. In FIG. 12, the line-of-sight area of the GPS/VICS antenna 114 of the present embodiment is illustrated by an area partitioned by the one-dotted dashed lines.

In the present embodiment, the GPS/VICS antenna 114 is located rearward than the telephone antenna 118. Therefore, as shown in FIG. 12, it is possible to enlarge the line-of-sight area of the GPS/VICS antenna 114. In particular it is possible to enlarge a zenith-direction-centered portion of the GPS/VICS antenna 114 in the vehicle front-rear direction, as compared to a case where the GPS/VICS antenna 114 is located frontward than the telephone antenna 118. In the above, the zenith-direction centered portion of the GPS/VICS antenna 114 is determined by, for example, a positional relationship between the rear end portion 21b of the roof 21 of the vehicle 20 and the GPS/VICS antenna 114.

According the present embodiment in particular, since the GPS/VICS antenna 114 is located rearward than the telephone antenna 118 in the vehicle front-rear direction, and since the two antennas 113, 118 have a predetermined interval therebetween, the GPS/VICS antenna 114 is located rearward than the rear end portion 21b of the roof 21 of the vehicle, as shown in FIG. 12. Therefore, it is possible to enlarge the line-of-sight area. In particular, it is possible to enlarge a zenith-direction-centered portion (i.e., a vertically upward portion) of the line-of-sight area.

As can be seen from the above, according to the vehicular combo antenna apparatus 110 of the present embodiment, it is possible to enlarge the line-of-sight area between the GPS/VICS antenna 114 and the infrastructure corresponding to the GPS/VICS antenna 114 with respect to the zenith direction, as shown in FIG. 12.

Moreover, as shown in FIG. 12, since the vehicular combo antenna apparatus 110 is placed inside the rear tray 26 of the vehicle 20, design improvement is achievable. Alternatively, the vehicular combo antenna apparatus 110 may be placed on the upper surface of the rear tray 26. Alternatively, the vehicular combo antenna apparatus 110 may be placed directly below the rear windshield 27 and may be placed at a part other than the rear tray 26.

The third antenna, which has directivity generally in the zenith direction, is not limited to the GPS/VICS antenna 114. The antenna for GPS by itself or the antenna for VICS by itself may be solely employed as the third antenna. An antenna having directivity generally in the vertical direction other than the above-described antennas may be employed as the third antenna.

The fourth antenna is not limited to the telephone antenna 118. An antenna different in directivity from the third antenna may suffice as the fourth antenna. Therefore, the short range communication antenna 113 illustrated in the first, second and third embodiments may be employed as the fourth antenna. In this case, the short range communication antenna 113 can act as the first antenna or the fourth antenna, and the GPS/VICS antenna 114 can act as the second antenna or the third antenna.

In the present embodiment, it is assumed that the vehicle does not have a wiper on a rear side. However, if the vehicle has a wiper on the rear side, the present embodiment can involve the similar advantages.

Embodiments of the present invention are not limited to the above embodiment and modifications. That is, the above embodiments and modification can be modified and/or combined in various ways without departing the scope and sprit of the present invention.

The present disclosure has the following aspects.

According to a first aspect, a vehicular combo antenna apparatus includes multiple of antennas received in a same housing. The multiple antennas include two antennas that are arranged along a front-rear direction of a vehicle, and that are a first antenna for short range communication and a second antenna different in directivity from the first antenna. The first antenna is located to have an inclination with a predetermined acute angle relative to a horizontal direction, so that a first portion of the first antenna is located above a second portion of the first antenna in a vertical direction, the first portion being distant from the second antenna as compared to the second portion, the second portion being closer to the second antenna as compared to the first portion; and a radiation element part of the first antenna is located above the second antenna in the vertical direction. The second antenna is located on a radio wave radiation side of the first antenna, the radio wave radiation side being a side of the first antenna toward which the first antenna radiates a radio wave.

According to the above-described vehicular combo antenna apparatus of the first aspect, the radiation element part of the first antenna for short range communication is located above the second antenna in the vertical direction. According to a vehicular combo antenna apparatus of a comparison example, a radiation element part of a first antenna is located below a second antenna in the vertical direction. When attachment position of the vehicular combo antenna apparatus to a vehicle is assumed to the be same between the vehicular combo antenna apparatus of the first aspect and that of the comparison example, the radiation element part of the vehicular combo antenna apparatus of the first aspect is located above that of the comparison example in the vertical direction. Therefore, in the vehicular combo antenna apparatus of the first aspect, elevation angle of a line-of-sight area can be made a low elevation angle.

Moreover, according to the above-described vehicular combo antenna apparatus of the first aspect, the second antenna is located on the radio wave radiation side of the first antenna. According to the comparison example, the second antenna is located on one side the first antenna, the one side being opposite to the radio wave radiation side. When attachment position of the vehicular combo antenna apparatus to a vehicle is assumed to the be same, the vehicular combo antenna apparatus of the first aspect can have, along the vehicle front-rear direction, a larger distance between a part of the vehicle determining a vertically lower portion of the line-of-sight area and the first antenna, as compared to the comparison example. Therefore, in the vehicular combo antenna apparatus of the first aspect, the elevation angle of the line-of-sight area can be made a lower elevation angle.

Furthermore, according to the above-described vehicular combo antenna apparatus of the first aspect, the radiation element part of the first antenna is located above the second antenna in the vertical direction. Therefore, while the second antenna is located on the radio wave radiation side of the second antenna, the first antenna can perform favorable two-way wireless communication with an infrastructure that corresponds to the first antenna.

As can be seen from the above, the vehicular combo antenna apparatus of the first aspect, which includes the multiple antenna received in the same housing, can ensure a favorable line-of-sight area between the first antenna for short range communication and the infrastructure corresponding to the first antenna, as compared to a conventional apparatus.

In the above, the short range communication includes two-way wireless communication in a relatively small range used in ITS (Intelligent Transport System) for example. For example, the short range communication may include DSRC (Dedicated Short Range Communications). Alternatively, the short range communication may include WAVE (Wireless for the Vehicular Environment) in US.

The above vehicular combo antenna apparatus may be configured in the following way. The vehicular combo antenna apparatus may be placed inside an instrument panel of the vehicle or placed on an upper surface of the instrument panel. The first antenna may be located rearward than the second antenna in the front-rear direction of the vehicle.

According to the above configuration, it is possible to make longer, along the vehicle front-rear direction, a distance between the first antenna and a member such as a hood of a vehicle body, a metal member of a front wiper and the like, thereby causing the line-of-sight area of the first antenna to have a low elevation angle.

When the vehicular combo antenna apparatus including the multiple antennas is placed inside, an instrument panel, design improvement is achievable.

The above vehicular combo antenna apparatus may be configured so that the first antenna is an ETC antenna. An ETC system, which is one example of a DSRC-related system, is such a system that when a vehicle is traveling on a toll road having a toll station such as an express way and the like, wireless communication between the ETC antenna and a road side apparatus (i.e., base station) disposed in the toll station can allow automatic payment of the toll without stop of the vehicle. The ETC antenna can be used for processing such automatic payment, and therefore can be preferably used in the vehicular combo antenna apparatus.

Alternatively, the above vehicular combo antenna apparatus may configured in the following way. The vehicular combo antenna apparatus is placed inside a rear tray of the vehicle or placed on an upper surface of the rear tray. The first antenna is located frontward than the second antenna in the front-rear direction of the vehicle.

According to the above configuration, it is possible to make longer, along the vehicle front-rear direction, a distance between the first antenna and a member such as a border part (e.g., a trunk lid) of a rear windshield, a metal member of a rear wiper and the like. Therefore, the elevation angle of the first antenna can be made a low elevation angle when the two-way wireless communication is performed between the first antenna and an infrastructure located rearward of the vehicle.

The above vehicular combo antenna apparatus may be configured so that the second antenna is at least one of a GPS antenna and a VICS antenna.

In typical, the GPS antenna and the VICS antenna have directivity generally in a vertically upper direction. Thus, it may be typically preferable to ensure that the line-of-sight area of each of the GPS antenna and the VICS antenna has a larger area around the vertically upper direction (i.e., the zenith direction). According to the above configuration, the second antenna is located on the radio wave radiation side of the first antenna. Thus, even when the vehicle combo antenna apparatus is mounted to any one of the instrument panel and the rear tray, it is possible to enlarge the line-of-sight area, in particular a zenith-direction-centered portion (i.e., an vertically upward portion) of the line-of-sight area, as compared to a case where the second antenna is located on one side of the first antenna opposite to the radio wave radiation side.

As can be seen from the above, it is possible to ensure a favorable line-of-sight area between the second antenna, which has directivity generally in the vertically upward direction, and the infrastructure corresponding to the second antenna.

According to a second aspect, a vehicular combo antenna apparatus located inside an instrument panel of a vehicle or located on an upper surface of the instrument panel includes multiple antennas received in a same housing. The multiple antennas include two antennas that are arranged along a front-rear direction of the vehicle, and that are a third antenna having directivity generally in a vertically upward direction and a fourth antenna different in directivity from the third antenna. The third antenna is located frontward than the fourth antenna in the front-rear direction of the vehicle.

According to the above vehicular combo antenna apparatus of the second aspect, the third antenna is located frontward than the fourth antenna with the vehicular combo antenna apparatus being mounted to the instrument panel. According to a comparison example, a third antenna is located rearward than a fourth antenna with a vehicular combo antenna apparatus being mounted to the instrument panel. When the attachment position of the vehicular combo antenna apparatus to the vehicle is assumed to be the same between the second aspect and the comparison example, the third antenna of the second aspect is located frontward than the third antenna of the comparison example. Therefore, the vehicular combo antenna apparatus of the second aspect can make lager the line-of-sight area, in particular, can make larger a zenith-direction-centered portion (a vertically-upward portion) of the line-of-sight area.

As can be seen from the above, it is possible to ensure a favorable line-of-sight area between the third antenna, which has directivity generally in the vertically upward direction, and an infrastructure corresponding to the third antenna.

According to a third aspect, a vehicular combo antenna apparatus located inside a rear tray of a vehicle or located on an upper surface of the rear tray include multiple antennas received in a same housing. The multiple antennas include two antennas that are arranged along a front-rear direction of the vehicle, and that are a third antenna having directivity generally in a vertically upward direction and a fourth antenna different in directivity from the third antennal. The third antenna is located rearward than the fourth antenna in the front-rear direction of the vehicle.

According to the above vehicular combo antenna apparatus of the third aspect, the third antenna is located rearward than the fourth antenna with the vehicular combo antenna apparatus being mounted to the rear tray. According to a comparison example, a third antenna is located frontward than a fourth antenna with a vehicular combo antenna apparatus being mounted to the instrument panel. When the attachment position of the vehicular combo antenna apparatus to the vehicle is assumed to be the same between the third aspect and the comparison example, the third antenna of the third aspect is located rearward than the third antenna of the comparison example. Therefore, the vehicular combo antenna apparatus of the third aspect can make lager the line-of-sight area, in particular can make larger a zenith-direction-centered portion (a vertically-upward portion) of the line-of-sight area.

As can be seen from the above, it is possible to ensure a favorable line-of-sight area between the third antenna, which has directivity generally in the vertically upward direction, and an infrastructure corresponding to the third antenna.

The above vehicular combo antenna apparatus may be configured so that the third antenna is at least one of a GPS antenna and a VICS antenna.

Embodiments of the present invention are not limited the above embodiments and modifications thereof. That is, the above embodiments and modifications thereof may be modified and/or combined in various ways without departing from the sprit and scope of the invention.

What is claimed is:

1. A vehicular combo antenna apparatus comprising:
a plurality of antennas received in a same housing,
wherein:
the plurality of antennas includes two antennas that are arranged along a front-rear direction of a vehicle, and that are a first antenna for short range communication and a second antenna different in directivity from the first antenna;
the first antenna is located to have an inclination with a predetermined acute angle relative to a horizontal direction, so that:
a first portion of the first antenna is located above a second portion of the first antenna in a vertical direction, the first portion being distant from the second antenna as compared to the second portion, the second portion being closer to the second antenna as compared to the first portion; and
a radiation element part of the first antenna is located above the second antenna in the vertical direction; and
the second antenna is located on a radio wave radiation side of the first antenna, the radio wave radiation side being a side of the first antenna toward which the first antenna radiates a radio wave.

2. The vehicular combo antenna apparatus according to claim 1, wherein:
the vehicular combo antenna apparatus is placed inside an instrument panel of the vehicle or placed on an upper surface of the instrument panel; and
the first antenna is located rearward than the second antenna in the front-rear direction of the vehicle.

3. The vehicular combo antenna apparatus according to claim 1, wherein:
the vehicular combo antenna apparatus is placed inside a rear tray of the vehicle or placed on an upper surface of the rear tray; and
the first antenna is located frontward than the second antenna in the front-rear direction of the vehicle.

4. The vehicular combo antenna apparatus according to claim 2, wherein:
the first antenna is an ETC antenna.

5. The vehicular combo antenna apparatus according to claim 1, wherein
the second antenna is at least one of a GPS antenna and a VICS antenna.

6. A vehicular combo antenna apparatus located inside an instrument panel of a vehicle or located on an upper surface of the instrument panel, the vehicular combo antenna apparatus comprising:
a plurality of antennas received in a same housing,
wherein:
the plurality of antennas includes two antennas that are arranged along a front-rear direction of the vehicle, and that are a third antenna having directivity in a vertically upward direction and a fourth antenna different in directivity from the third antenna; and
the third antenna is located frontward than the fourth antenna in the front-rear direction of the vehicle.

7. A vehicular combo antenna apparatus located inside a rear tray of a vehicle or located on an upper surface of the rear tray, the vehicular combo antenna apparatus comprising:
a plurality of antennas received in a same housing,
wherein the plurality of antennas includes two antennas that are arranged along a front-rear direction of the vehicle, and that are a third antenna having directivity in a vertically upward direction and a fourth antenna different in directivity from the third antennal; and
the third antenna is located rearward than the fourth antenna in the front-rear direction of the vehicle.

8. The combo antenna according to claim 6, wherein:
the third antenna is at least one of a GPS antenna and a VICS antenna.

9. The vehicular combo antenna apparatus according to claim 1, wherein:
the first antenna has directivity in a vehicle front direction or a vehicle rear direction.

10. The vehicular combo antenna apparatus according to claim 1,
the second antenna has directivity in a vertically upward direction.
